(19) United States
(12) Patent Application Publication
(10) Pub. No.: US 2011/0159231 A1
(43) Pub. Date: Jun. 30, 2011

(54) SYSTEMS AND METHODS FOR LASER ETCHING CARPET

(75) Inventor: Robert D. Hutchison, Rocky Face, GA (US)

(73) Assignee: Mohawk Carpet, LLC

(21) Appl. No.: 12/850,409

(22) Filed: Aug. 4, 2010

Related U.S. Application Data
(60) Provisional application No. 61/231,207, filed on Aug. 4, 2009.

(51) Int. Cl. D05C 17/00; B23K 26/36; B23K 26/00

(52) U.S. Cl. 428/95; 216/7; 219/121.68

(57) ABSTRACT

Various embodiments of the present invention provide systems and methods for etching carpets and carpet substrates. More particularly, various embodiments direct a laser beam at a carpet substrate such that energy is transferred to the carpet substrate in the form of heat. This heat alters the portion of the carpet substrate surface struck by the laser. The laser beam is guided along a pre-determined path to create a desired pattern in the carpet substrate. The desired pattern may include variations in the depth of etching of the carpet substrate.

### CROSS-REFERENCE TO RELATED APPLICATIONS

This application claims the benefit of U.S. Provisional Application No. 61/231,207, filed Aug. 4, 2009, which is incorporated by reference in its entirety.

### FIELD OF THE INVENTION

The present invention is generally directed to systems and methods for laser etching a substrate. More particularly, embodiments of the present invention provide systems and methods for laser etching carpet.

### BACKGROUND OF THE INVENTION

Carpet substrates generally comprise yarns stitched through a primary backing to form loops. The loops create the wear surface of the carpet substrate. These loops may be cut to form a pile surface. Tufting machines typically have one or more needle bars with a plurality of needles threaded with individual yarns. The needle bars reciprocate to pass the needles carrying the yarn through a moving primary backing substrate to form loops. Yarn is fed to the needle bars from yarn feed rolls, which are typically controlled by clutches or servomotors. Different tuft heights, whether loop or cut, may be formed by controlling the clutches or servomotors to feed more or less yarn to the needle bars. An example of a textured surface having tufted pattern effects is disclosed in U.S. Pat. Nos. 5,383,415 and 5,549,064. In those patents, the feed of the yarns to the needles of the needle bar is controlled to provide selected high or low tufts in warpwise and weftwise adjacent stitches. Although these techniques can impart texture to a carpet or carpet tile substrate, the precision of the patterns is limited to the density of the stitches. There is a need in the industry for systems and methods for imparting a texture or pattern to carpet that can provide higher resolution patterns and/or greater variety of patterns than are attainable by manipulating the density of stitches.

### BRIEF SUMMARY OF THE INVENTION

Various embodiments of the present invention provide systems and method for producing unique laser etched carpet tiles.

In one aspect of the invention, a laser etching system is provided. This laser etching system includes a template defining a cavity sized to receive a carpet tile and including a biasing member configured to urge the carpet tile against a boundary surface of the cavity; a laser apparatus configure to generate a laser beam; and a beam targeting system comprising a plurality of lens, moveable mirrors and a controller configured to selectively target the laser beam along a path within the template cavity relative to the boundary surface of the cavity at a speed such that a carpet tile positioned within the template cavity would be etched by the laser beam.

In another aspect of the invention, a method of laser etching a carpet tile having a tufted carpet substrate with a first linear edge and a second linear edge substantially perpendicular to the first linear edge is provided. This method includes the steps of: disposing the carpet tile in a cavity defined by a template; biasing the first and second linear edges against a first and second boundary of the cavity defined by the template; and directing a the laser apparatus to generate a laser striking the carpet tile at a predetermined location relative to the first and second boundary surfaces of the cavity and to follow a predetermined path.

In a further aspect of the invention, a carpet tile is provided. This carpet tile includes a carpet substrate comprising face yarn tufted into a primary backing wherein the face yarns extend outwardly from one face of the primary backing and wherein a precoat is disposed on an opposite face. The carpet substrate further includes a first laser etched area wherein the face yarn is partially or wholly burned such that the height of the first laser etched area is reduced; a second laser etched area wherein the face yarn is partially or wholly burned such that the height of the second laser etched area is less than the first laser etched area; and a non-laser etched area, where the first laser etched area and the non-laser etched area are configured to engage footwear traversing the carpet tile, and the second laser etched area have a height and a width configured not to engage the footwear traversing the carpet tile.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a cross-section of a carpet tile 10 in accordance with an embodiment of the present invention.

FIG. 2 is a schematic diagram of a laser etching system 20 in accordance with an embodiment of the present invention.

FIG. 3 is a block diagram of a controller 40 in accordance with an embodiment of the present invention.

FIG. 4 is a laser etched walk-off carpet tile 100 in accordance with an embodiment of the present invention.

FIG. 5 is a schematic diagram of a cross-section of a carpet tile in accordance with an embodiment of the present invention.

FIGS. 6A, B are schematic diagrams of a laser etching system 80 in accordance with an embodiment of the present invention.

### DETAILED DESCRIPTION OF THE INVENTION

The present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Generally described, various embodiments of the present invention provide systems and methods for etching carpets and carpet substrates. More particularly, various embodiments direct a laser beam at a carpet substrate such that energy is transferred to the carpet substrate in the form of heat. This heat alters the portion of the carpet substrate surface struck by the laser. The laser beam is guided along a pre-determined path to create a desired pattern in the carpet substrate. The desired pattern may include variations in the depth of etching of the carpet substrate.

In various embodiments, the carpet substrates include carpet tiles manufactured using any known or developed process. The carpet tiles may be cut pile, cut and loop construction or other style of carpet tile. The carpet tiles may include a uniform or a patterned textured surface. In various embodiments, the carpet tiles are substantially uniform in size. For example, the carpet tiles may be 18 inches by 18 inches or 36 inches by 36 inches. Of course, other embodiments may include tiles of different sizes and shapes.

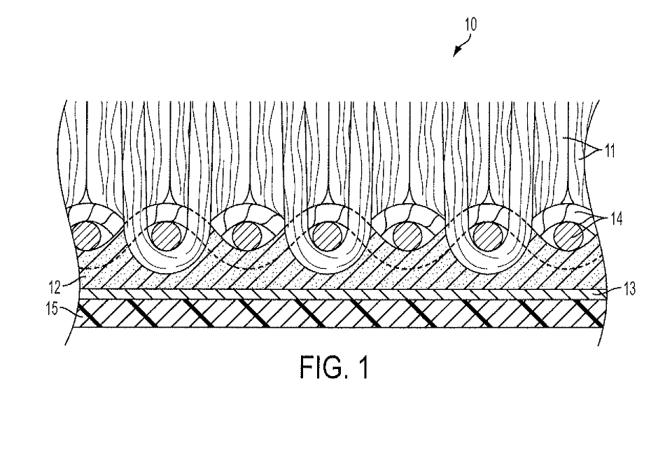

FIG. 1 illustrates a carpet construction in accordance with an embodiment of the present invention. The illustrated carpet substrate includes face yarn 11, tufted into a woven or spun bonded fabric or scrim 14 known as a primary backing. The primary backing 14 has pile yarns 11 tufted therethrough extending outwardly from one face. A primary backcoating or precoat 12 is applied to the opposite face, and a fiberglass layer 13 applied thereto. The fiberglass layer 13 may be a woven or nonwoven material. A secondary backcoating 15 may then be applied over the fiberglass coating. Some embodiments may include additional layers between the primary backing 12 and the secondary backcoating 15. The primary backcoating or precoat 12 may comprise latex, PVC (polyvinylchloride), EVA (ethylene vinyl acetate), or other polymer-based material, and the secondary backcoating 15 may also comprise or include polymers.

The face yarn 11 may be formed from nylon, polypropylene, acrylic, polyester, wool, cotton or other material. In various embodiments, the carpet tile includes a plurality of different yarn material types to provide varying textures in the carpet substrate.

Once the carpet substrate has been manufactured, it may be cut into tiles having substantially uniform size. In various embodiments, the carpet tiles are 18 inches by 18 inches or 36 inches by 36 inches. Other embodiments may include tiles of different sizes and shapes. After being cut to size, the carpet tiles may then be laser etched using a laser system in accordance with various embodiments of the present invention. In other embodiments, the carpet is not cut into tiles and is instead laser etched in a broadloom state.

The Laser System

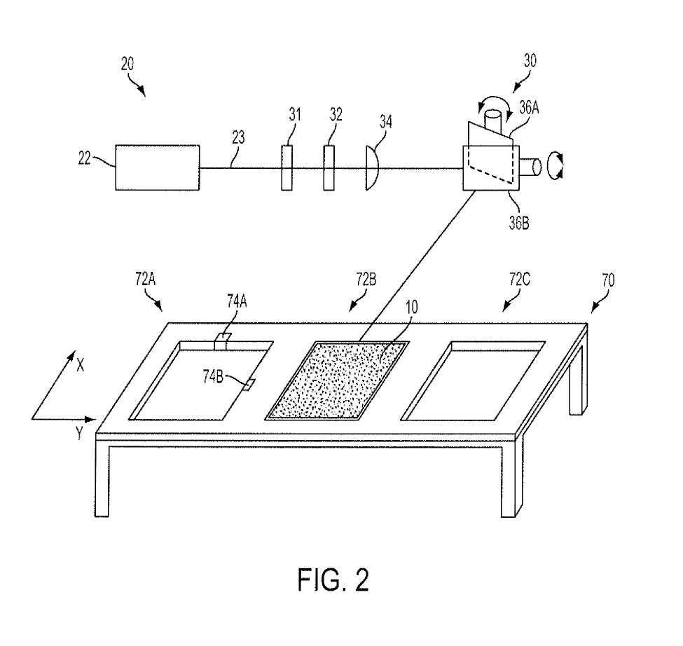

FIG. 2 illustrates a laser system 20 in accordance with an embodiment of the present invention. The laser system 20 includes a laser apparatus 22, a beam targeting system 30, and a template 70. The laser apparatus 22 is a device that emits electromagnetic radiation (i.e. light). In various embodiments, the laser apparatus 22 is a CO2 laser; however, other embodiments may employ other types of lasers such as other gas lasers, solid state lasers or other known or developed devices for emitting electromagnetic radiation. In various embodiments, the laser beam 23 emitted from the laser apparatus 22 is directed by the beam targeting system 30 under control of the controller 40 (not shown) onto a carpet tile 10 positioned by the template 70. The controller 40 may adjust the beam targeting system 30 to direct the laser beam to trace a pattern onto the carpet substrate 10. As the laser beam 23 is directed along the predetermined path, it transfers energy to the carpet substrate thereby altering the respective surface by vaporizing, burning, wholly or partially melting or otherwise altering the appearance of the respective surface. In various embodiments, the etching process imparts a mechanical roughness or abrasiveness to the carpet yarn. After being struck by the laser, the molten polymer cools to form a height reduced surface with an abrasive character that may be capable of removing soil or other debris from the soles of footwear.

In the illustrated embodiment, the beam targeting system 30 includes a first expander lens 31, a second expander lens 32, an objective lens 34 and a series of mirror galvanometers 36A, B. The laser beam 23 emitted from the laser apparatus 22 passes through the first expander lens 31, the second expander lens 32, and then the objective lens 34 prior to striking the mirror galvanometers 36A, B. In various embodiments, the linear distance between the first expander lens 31 and second expander lens 32 may be adjusted by the controller 40 to adjust the focal point or the width of the laser beam 23 at the point it strikes the carpet substrate 10.

In various embodiments, the beam targeting system 30 includes two mirror galvanometers 36A, B that provide two dimensional control over the target location of the laser beam 23 with reference to the carpet substrate 10 held by the template 70. As will be understood by those skilled in the art, mirror galvanometers 36A, B include mirrors attached to the rotating shaft of a galvanometer. The controller 40 sends signals to the mirror galvanometers causing them to selectively rotate, which in turn alters the location of the laser beam on the carpet substrate 10 held by the template 70. The axis of rotation for the two mirrors are oriented such that rotation of one of the mirrors causes the laser beam 23 to move along a first axis (e.g., the X-axis of the template) and rotation of other mirror causes the laser beam 23 to move along a different axis substantially perpendicular to the first axis (e.g., the Y axis of the template). Thus, by selectively rotating the two mirror galvanometers, the laser beam 23 can be guided along a predetermined path to create a design or pattern on a carpet tile 10 held by the template 70.

In various embodiments, the controller 40 is a computer programmed to control the direction, speed of movement, and focus of the laser beam 23 aimed at the carpet substrate 10. The controller 40 may be programmed to direct the laser beam 23 to trace a predetermined path thereby etching the path into the carpet substrate 10.

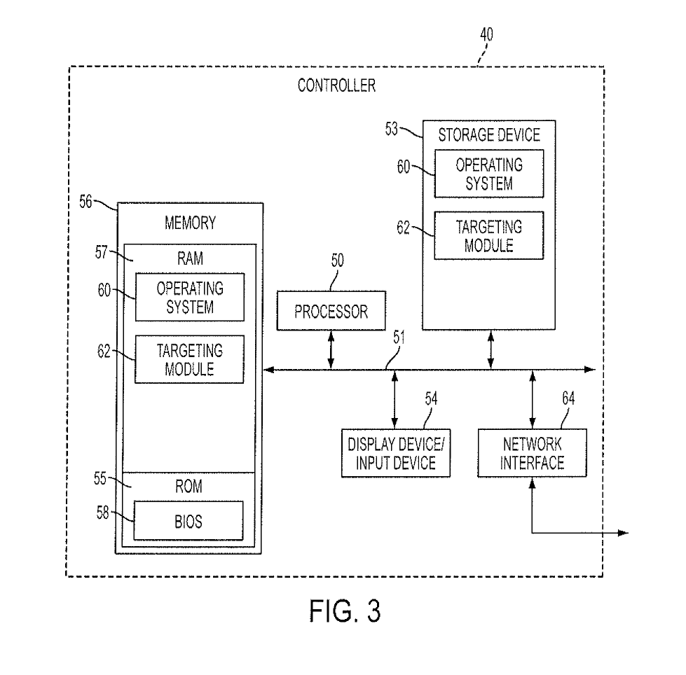

FIG. 3 is a schematic diagram of a controller 40 according to one embodiment of the invention. As may be understood from this figure, in this embodiment, the controller 40 includes a processor 50 that communicates with other elements within the controller 40 via a system interface or bus 51. Also included in the controller 40 is a display device/input device 54 for receiving and displaying data. This display device/input device 54 may be, for example, a keyboard or pointing device that is used in combination with a monitor. The controller 40 further includes memory 56, which preferably includes both read only memory (ROM) 55 and random access memory (RAM) 57. The server's ROM 55 is used to store a basic input/output system 58 (BIOS), containing the basic routines that help to transfer information between elements within the controller 40.

In addition, the controller 40 includes at least one storage device 53, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 53 is connected to the system bus 51 by an appropriate interface. The storage devices 53 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 57. Such program modules include an operating system 60, and a targeting module 62 that control certain aspects of the operation of the controller 40, with the assistance of the processor 50 and the operating system 60.

Also located within the controller 40 is a network interface 64, for interfacing and communicating with other elements of a computer network. It will be appreciated by one of ordinary skill in the art that one or more of the controller 40 components may be located geographically remotely from other controller 40 components. Furthermore, one or more of the components may be combined, and additional components performing functions described herein may be included in the controller 40.

The targeting module 62 generally controls various parameters of the laser system 20 including the targeting of the laser beam 23 onto the carpet substrate 10 and the focus of the laser beam 23. The targeting parameter is controlled by sending instructions to the mirror galvanometers 36A, B to adjust the relative rotation of the mirrors, which cause the laser beam 23 to track along a pre-programmed path. As part of this targeting, the speed with which the laser beam 23 follows the pre-determined path may be controlled by controlling the speed of the rotation of the mirrors. The targeting module 62 may also provide instructions to a mechanism that alters the linear distance between the first expander lens 31 and the second expander lens 32 to adjust the focus of the laser beam 23. By adjusting this linear distance, the width of the laser at the point at which it contacts the carpet substrate 10 may be widened or narrowed.

In various embodiments, the etch design is provided to the controller 40 in a vector format. In the vector format, the various design elements are described in a series of vectors. In other embodiments, raster or other known or developed formats, such as PLT, DXF, BMP, PCX, Tiff, JPEG, GIF, and mcl, may be used to define a pattern to be etched into a carpet substrate.

As the laser beam 23 strikes the carpet substrate, energy is transferred to the carpet substrate in the form of heat and this heat alters the portion of the carpet substrate struck by the laser. In various embodiments, the fibers struck by the laser are vaporized, burned, wholly or partially melted or otherwise altered to provide a visual indication of the path followed by the laser beam thereby creating a pattern in the carpet substrate. The depth of vaporization of the carpet substrate may be affected by adjusting the power of the laser and/or the speed at which the laser passes over the carpet substrate. These parameters may be controlled by the controller 62. Additionally, the widening and narrowing of the laser beam may also affect the depth of vaporization. The width of the laser may be adjusted by altering the distance between the first and second expander lenses. Depending on the desired pattern, the controller 40 may adjust the speed, the power of the laser and/or the width of the laser beam to create a desired depth. For example, the speed and/or power may be kept constant such that the etching depth varies with the width of the laser beam 23.

In some embodiments, a shutter device (not shown) may be placed in the path of the laser. The shutter may be configured to selectively block the laser beam 23 under control of the controller 40 in order to produce a design that has discontinuous design elements. It should be understood that an etched pattern or design may include continuous or discontinuous design elements. When the design elements are discontinuous, the shutter may be closed to allow re-targeting of the laser beam without etching the carpet.

Discontinuous design elements may also be created without a shutter device by altering parameters of the laser beam to re-target the laser beam without permanently altering the surface of the carpet substrate. For example, the power of the laser 22 may be reduced while the beam is retargeted. In other embodiments, the laser beam 23 may be retargeted at a rapid speed or the laser width increased such that insufficient energy is transferred to permanently alter the surface of the substrate. Any combination of these techniques may be used to etch discontinuous design elements in a carpet substrate.

As will be understood by those of skill in the art, the focus of the laser may need to be adjusted as the etching location moves from the center of the template to the edges of the template. In order to compensate for varying distances between the laser and the substrate to be etched, the focusing of the laser may be adjusted. For example the distance between the laser 22 and the outer edge of the template 70 is greater than the distance between the laser 22 and the mid-point of the template 70. In various embodiments, the focusing of the laser may be adjusted by altering the linear distance between the first and second expander lens.

The template 70 is a substantially planar structure that is configured to hold one or more carpet tiles 10. The template may be mounted to a table or other sturdy structure and different templates may be used for different sized carpet tiles. In the illustrated embodiment, the template 70 defines three carpet stations 72A-C, where each station is configured to position a single carpet tile. In other embodiments, the template may be configured to hold more or less that three carpet tiles. The stations may be configured to position carpet tiles of the same or different sizes.

In the illustrated embodiment, each station in the template 70 includes a cavity sized and shaped to accept a carpet tile. In some embodiments, the stations may include one or more biasing members that urge the carpet tile against a specific side or boundary of the cavity. For example, in FIG. 2 station 72A includes biasing members 74A, B that are configured to engage two adjacent edges of a carpet tile thereby urging the carpet tile against opposite sides of the cavity. In the illustrated embodiments, the two biasing members 74A, B are configured to urge a carpet tile towards the lower left corner as shown in FIG. 1 In other embodiments, each station may include two orthogonally oriented locating members with biasing members urging edges of the carpet tile into engagement with the locating members.

In FIG. 2, one carpet tile 10 is placed in the template 70 (i.e. station 72B). Carpet tiles may also be disposed in the other stations 72A, 72C. After the carpet tiles are loaded, the laser cycle may be initiated. In various embodiments, the controller 40 may send signals to the beam targeting system 30 instructing it to direct the laser beam 23 to etch the same designs in all three carpet tiles or different design in some or all of the held carpet tiles.

In further embodiments, the laser apparatus may provide a laser beam targeting a fixed location where a template holding a carpet tile positions the carpet tile into the path of the laser beam and moves the tile such that a desired pattern is etched into the carpet tile by the laser. To position the carpet tile into the path of the laser beam, the template may be attached to a turntable, linear shuttle or other conveying device. Additionally, further movement of the template may be facilitated by attachment to an X-Y table that has the capability to move the template in two directions within a plane. The X-Y table may be used in conjunction with the conveying device. In additional embodiments, the laser beam and the template may both move to facilitate etching of a pattern into a carpet tile.

The laser etching process may be performed in a controlled atmosphere. For example, the laser etching area may occur in an atmosphere of substantially N2 or other gas that can alter the character of the ablated surface.

In further embodiments, the carpet is provided in a roll form (e.g., broadloom) and continuously fed into the laser system. In various embodiments, the laser etching occurs after the carpet backing is applied. However, in other embodiments, the laser etching may occur prior to application of a backing.

The broadloom carpet could be feed continuously through the laser etching device where a laser etches a pattern in the carpet as it passed. In other embodiments, the carpet could be feed in sections such that the carpet is substantially stationary during the etching cycle. After laser etching, the roll of carpet may be cut into tiles or used in a broadloom state.

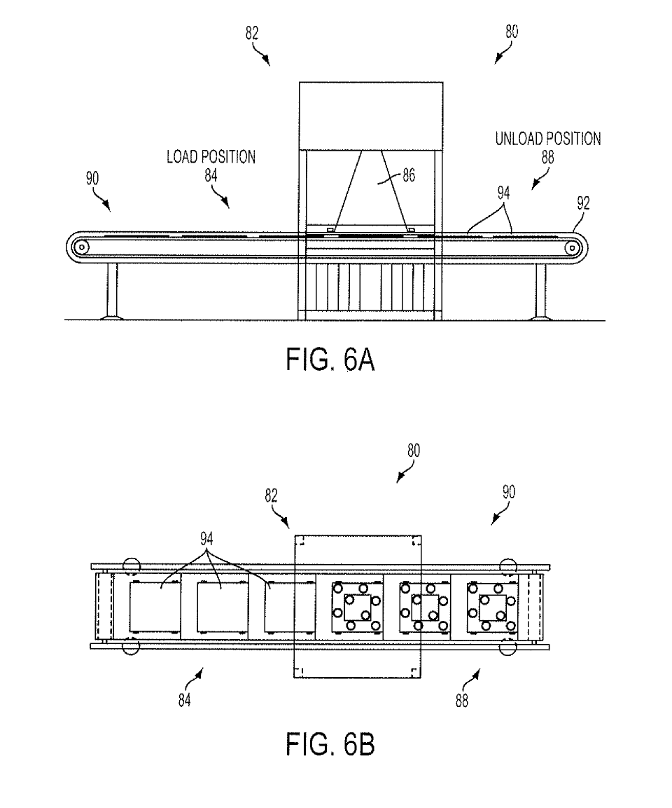

FIGS. 6A, B illustrate a laser etching system 80 in accordance with various embodiments of the present invention. This system includes a laser system 82 and a conveying system 90. The laser system 82 includes a laser apparatus, beam targeting system and a controller as generally described with reference to the laser system 10. The conveying system 90 includes a conveying apparatus 92 and a plurality of templates 94. In various embodiments, the conveying apparatus 92 is a conveyor belt, and templates 94 are attached to the conveyor belt. In use, a carpet tile is placed in one of the templates upstream of the laser system 82, and it is conveyed from a load position 84 to an etching position 86, and then to an unload position 88. In various embodiments, the conveyor stops while the laser system 82 etches the carpet tile. Sensors or positive stops may be used to accurately locate the template and the associated carpet tile within the etching position 86. After completion of the etching cycle, the conveyor transfers the template carrying the etched carpet tile out of the etching position and a new carpet tile into the etching position 86. In other embodiments, the conveyor may continually move the template through the etching position 84 and the laser system 82 etches the carpet as it passes through the etching position 84.

In various other embodiments, the conveying system 90 may comprise a shuttle with a plurality of templates that are moved into and out of the etching zone. For example, the shuttle may comprise two templates in which one template is shuttled into the etching zone while the other is simultaneously shuttled out. In this way, the etched tile held in a first template may be removed and a non-etched tile placed in the first template while a tile held in the second template is being etched. This process may be reversed once the etching cycle is completed.

Laser Etched Carpets

The laser etching process may be applied to any style of carpet. In various embodiments, carpet tiles are used because of their dimensional stability. The carpet tiles may include a texture created by a mixed cut and loop construction and/or height variations. In various embodiments, the laser etching may be focused on either the cut pile sections or loop sections. Additionally, the laser etched design may include elements that cross the height differences or focus on carpet tufts of particular heights.

In some embodiments, less expensive styles of carpet may be laser etched to mimic more expensive carpet styles. For example, a tufted carpet tile may be laser etched to mimic a woven carpet construction, which includes horizontal and vertical features. For carpet tile embodiments, the horizontal and vertical features may cross the seams between adjacent carpet tiles thereby giving the visual impression of a woven carpet construction.

A common issue faced by the carpet tile industry is to minimize the appearance of seams between the carpet tiles. Some techniques used to minimize the appearance of seams include printing elaborate patterns on the carpet tiles to overwhelm the senses thereby obscuring the seams. Typically, these designs do not have elements that cross the seam due to variations in the printing process. Small variations can create mismatches at the seams, which may draw unwanted attention to the seam. By positively locating the carpet tiles in the template 70, the laser etching process can provide improved dimensional control over a conventional tile printing process such that design elements can be provided that bridge multiple tiles without substantial mismatch issues. In some embodiments, the resulting flooring system appears to be a broadloom carpet when in fact the flooring includes a plurality of individual carpet tiles with design elements bridging adjacent tiles.

In addition to aesthetics, laser etched patterns can also improve the performance of various types of carpet. In various embodiments, a laser is used to etch a pattern into a walk-off carpet. Walk-off carpets are typically placed proximate an entrance or exit of a building such as a home, office or retail location. The purpose of the walk-off carpet is to collect particulate matter and/or moisture from individuals' footwear when entering a building to reduce introduction of particulate matter and/or moisture into the building. The particulate matter may be dirt, dust, snow, ice, salt, organic matter, debris or other substances. These walk-off carpets may include particular types of fibers such as large monofill scraper type fibers (e.g., 300 denier), which engage particulate matter and/or moisture from individuals' footwear as they walk across the carpet. Other embodiments may use different types and sizes of yarn fiber.

To improve not only the aesthetics of the carpet but also the ability of walk-off carpets to remove and retain particular matter, the carpets may be laser etched. In various embodiments, multiple channels may be etched into the carpet in a direction that is transverse to the direction of travel of individuals entering the building. These channels can collect particulate matter from individual's footwear as they walk over the mat. In various embodiments, fill areas in a design may be laser etched with a corrugated pattern to further improve the collection of particulate matter. Furthermore, the laser etching process imparts an abrasive surface onto the carpet, which encourages removal and collection of particulate matter.

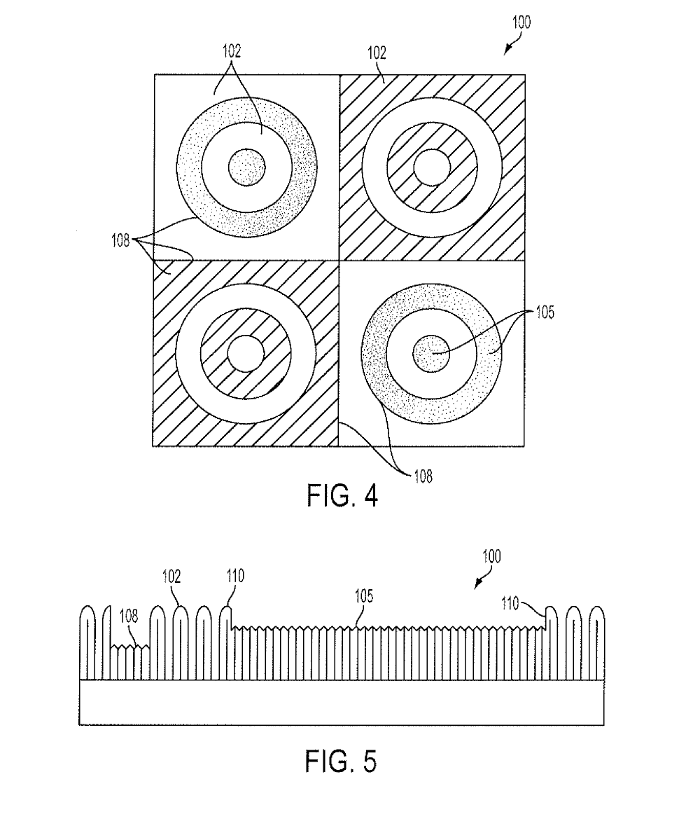

FIG. 4 illustrates a laser etched carpet tile 100 produced in accordance with an embodiment of the present invention. The illustrated embodiment includes a plurality of different design elements including relatively large etched areas 105 and relatively narrow etched channels 108. The relatively large etched areas 105 are configured to engage individuals' footwear as they walk across the walk-off carpet, while the etched surfaces in the channels 108 do not engage the individuals' footwear. Instead, these channels 108 are designed to trap or collect particulate matter.

The relatively large etched areas 105, in the illustrated embodiment, have a minimal etch depth. When an individual walks across these relatively large etched areas 105, the surrounded non-etched carpet 102 will temporarily deform to some degree due to the weight of the individual thereby allowing the etched surface 105 to contact the individual's footwear. Because the etched surface can be abrasive due to the melted polymer, this contact can urge particulate matter from the individual's footwear. Furthermore, particulate matter urged from the individual's footwear will tend to remain in the etched areas due to the height difference between the etched areas 105 and the non-etched carpet 102. In the illustrated embodiment, the center circle may have a diameter of approximately 1 inch. The annular ring may have a width of approximately ½ inch. The height difference between the etched areas 105 and the non-etched carpet 102 may be approximately 1/16 inch. Other embodiments may include larger or smaller etched design elements. In other embodiments, the etched areas 105 may be sized to engage a substantial portion of an individual's footwear without the need for the non-etched carpet to deform a substantial degree.

As noted previously, the etched channels 108 provide a different function from the etched areas 105 because an individual's footwear will likely not contact the etched surfaces within the channels 108. Instead, these etched channels 108 create cavities to catch moisture and/or particulate matter releasing from individuals' footwear whether from contact with the surrounding non-etched carpet or other reason. These cavities tend to trap the particulate matter for later remove using a vacuum or other cleaning technique. In the illustrated embodiment, the etched channels 108 are approximately 1/16 inch wide, with a depth of approximately 3/16 inch. Various embodiments of this laser etching technique have advantages over attempts to create channels or cavities using tufting techniques such as tufting different sized yarn. The laser etching process can provide more precise channels and the laser etching process is not subject to the same design limitations imposed on tufting techniques.

FIG. 5 illustrates a cross-section of a walk-off carpet tile 100 etched in accordance with an embodiment of the present invention. In this embodiment, the carpet substrate is a loop style carpet with face yarn 102 tufted into a backing 104, The reduced height areas were created using a laser etching process. With traditional carpet techniques, height changes are created by altering the height of individual tufts. Accordingly, the precision of the pattern created by height changes is directly dependent on the number of tufts per inch in the carpet substrate. In contrast, the precision of the laser etching is not directly related to the number of tufts per inch. As illustrated in FIG. 5, the laser can etch a full and/or partial tuft in creating the desired design. Although the FIG. 5 illustrates the laser etched areas with a portion of the total height of the tufted yarn 102 reduced as a result of the laser etching, the laser etching process may reduce the height of the yarn all the way to the backing 104.

Furthermore, the laser etching process creates a distinct edge 110 between the etched and non-etched surfaces. This edge can help facilitate removal of particulate matter from individuals' footwear as they walk across the walk-off carpet. As will be appreciated by those of skill in the art, typical carpet tiles with tufted height variations will have a more rounded or soft transition between the different heights, which can be less effective in removing particulate matter and/or moisture from footwear.

One of the benefits of various embodiments of the present invention is that the laser etching process creates dimensional texture on all fiber types it impacts, which is not removable. The aesthetic effect is permanent. This cannot be said for many other techniques for applying a design to a carpet substrate such as printing or dyeing. Printing and dyeing techniques face issues of color fastness. Furthermore, dyes used in the printing process are often pre-metalized dyes, which can have environmental concerns. Various embodiments of the laser etching process do not use pre-metalized dyes and therefore would not face the same environmental concerns. Other problems faced by printing and dyeing techniques, such as water usage, discharges, and effluents, are not issues with various embodiments of the lasering system.

A further potential benefit is that the abrasiveness of surfaces created using this process may have a higher coefficient of static friction, which could help reduce the occurrence of falls and injuries caused by falls. This could be especially beneficial on ramps or inclined surfaces where wet conditions may occur.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A laser etching system comprising:
a template defining a cavity sized to receive a carpet tile and including a biasing member configured to urge the carpet tile against a boundary surface of the cavity;
a laser apparatus configure to generate a laser beam; and
a beam targeting system comprising a plurality of lens, moveable mirrors and a controller configured to selectively target the laser beam along a path within the template cavity relative to the boundary surface of the cavity at a speed such that a carpet tile positioned within the template cavity would be etched by the laser beam.

2. The laser etching system of claim 1, wherein the template includes a plurality of biasing members and the boundary surface comprises a first surface and a second surface substantially perpendicular to the first surface.

3. The laser etching system of claim 1, wherein the template defines a second cavity sized to receive a carpet tile.

4. The laser etching system of claim 3, wherein the cavities are different sizes.

5. The laser etching system of claim 3, wherein the beam targeting system is configured to direct the laser beam along a second predetermined path within the second cavity.

6. The laser etching system of claim 5, wherein the predetermined path for the first cavity and the second predetermined path are substantially the same relative to the respective boundary surfaces.

7. The laser etching system of claim 1, further comprising a second template and wherein the template and the second template are secured to a conveying apparatus, which is configured to selectively move the templates into an etching position.

8. The laser etching system of claim 1, wherein the path and speed of the laser beam is pre-determined.

9. The laser etching system of claim 8, wherein the path is discontinuous.

9. The laser etching system of claim 1, wherein the path is discontinuous and comprises at lease some random design elements.

8. A method of laser etching a carpet tile having a tufted carpet substrate with a first linear edge and a second linear edge substantially perpendicular to the first linear edge, wherein the method comprises the steps of:
disposing the carpet tile in a cavity defined by a template;
biasing the first and second linear edges of the carpet tile against a first and second boundary surface of the cavity defined by the template; and
directing a the laser apparatus to generate a laser striking the carpet tile at a predetermined location relative to the first and second boundary surfaces of the cavity and to follow a predetermined path.

9. The method of claim 8 further comprising the step of:
shuttling the template from a loading position to a laser etching position.

10. The method of claim 9, wherein the step of shuttling the template from a loading position to a laser etching position further comprises simultaneously shuttling a different template from a laser etching position to a carpet tile unloading position.

11. The method of claim 8, further comprising the steps of:
disposing a second carpet tile in a second cavity defined by the template; and
directing the laser apparatus to generate a laser striking the second carpet tile at a predetermined location relative to a first and a second boundary surface of the second cavity and to follow a second predetermined path.

12. The method of claim 11, wherein the predetermine path for the carpet tile and the second predetermined path for the second carpet tile are substantially the same.

13. A carpet tile comprising:
a carpet substrate comprising face yarn tufted into a primary backing wherein the face yarns extend outwardly from one face of the primary backing and wherein a precoat is disposed on an opposite face;
wherein the carpet substrate further comprises:
a first laser etched area wherein the face yarn is partially or wholly burned such that the height of the first laser etched area is reduced;
a second laser etched area wherein the face yarn is partially or wholly burned such that the height of the second laser etched area is less than the first laser etched area; and
a non-laser etched area,
wherein the first laser etched area and the non-laser etched area are configured to engage footwear traversing the carpet tile, and
the second laser etched area have a height and a width configured not to engage the footwear traversing the carpet tile.

14. The carpet tile of claim 13, wherein the first laser area comprises a corrugated surface.

15. The carpet tile of claim 13, wherein the carpet substrate comprises a plurality of different yarn types.

16. The carpet tile of claim 13, wherein at least a portion of the face yarn comprises a scraper type yarn.
